(19) United States
(12) Patent Application Publication
(10) Pub. No.: US 2025/0350202 A1
(43) Pub. Date: Nov. 13, 2025

(54) LOAD TRANSIENT MINIMIZATION NEAR ZERO CROSSING OF VALLEY CURRENT OF POWER INDUCTOR IN A POWER CONVERTER

(71) Applicant: Cirrus Logic International Semiconductor Ltd., Edinburgh (GB)

(72) Inventors: Ilija JERGOVIC, Austin, TX (US); Markos KOSEOGLOU, Austin, TX (US); Siddharth MARU, Austin, TX (US); Bryan W. MCCOY, Mesa, AZ (US); John L. MELANSON, Austin, TX (US)

(73) Assignee: Cirrus Logic International Semiconductor Ltd., Edinburgh (GB)

(21) Appl. No.: 19/052,528

(22) Filed: Feb. 13, 2025

Related U.S. Application Data
(60) Provisional application No. 63/644,946, filed on May 9, 2024.

(51) Int. Cl. H02M 3/156; H02M 1/00

(52) U.S. Cl. CPC H02M 3/156; H02M 1/0009; H02M 1/0025

(57) ABSTRACT

A method may include measuring one or more of a first period of time in which a power inductor current through the power inductor is below zero and a second period of time taken by a voltage of a node of the power converter to drop below a predetermined threshold during a switching dead-time of the power converter. The method may also include, based on at least one of the first period of time and the second period of time, modifying one or more of a feedforward term to the control signal for controlling the plurality of switches, a loop bandwidth of a control loop comprising the closed loop controller, and a pulse width of the control signal.

### RELATED APPLICATION

The present disclosure claims priority to U.S. Provisional Patent Application No. 63/644,946 filed May 9, 2024, which is incorporated by reference herein in its entirety.

### FIELD OF DISCLOSURE

The present disclosure relates in general to circuits for electronic devices, including without limitation personal audio devices such as wireless telephones and media players, and more specifically, closed-loop control of power converters.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other loads. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter).

Power converters may be used in a portable device such as a smart phone, laptop computer, or wearable which is battery operated. Accordingly, the use of power in such devices must be judicious in order to ensure that the battery lasts as long as possible. Consequently, it may be desirable to use power converters only on an as-needed basis. Thus, for a large portion of time, a regulator implemented using a power converter may be off or in a lower power mode and may be turned on or activated only a short time prior to or exactly at the time the system requiring the regulator is powering up.

One example of a power management application that uses a power converter is a buck converter that generates a supply rail to a load at an output of the buck converter at a lower voltage than a battery voltage at the input of the buck converter. When the components loading the buck converter are powered down, the buck regulator may be operated in a low power mode in which the buck converter only switches when it is necessary to replenish charge to an output capacitance present at the output of the power converter. However, in many of these applications, the components loading the buck converter may power back on at any time, making a sudden current demand from the buck converter. In many instances, no prior intimation of the impending powering on of the components may be available, and hence the buck converter may have to respond to an instantaneous reduction on the output capacitance due to the applied load.

In many applications, a speedy response to such a load transient is desired. Accordingly, in such applications, a lower power mode may not be used, and the buck converter may operate in a pulse-width modulation mode (as opposed to lower-power pulse-frequency modulation mode) even in the absence of a load. For such power converters operating in a forced pulse-width modulation mode, the current flowing through a power inductor of the power converter may go negative, and energy may undesirably flow back and forth between the input and the output of the power converter to ensure no net energy is pushed to the output of the power converter.

A current level at which a power inductor of an inductive power converter switches from its demagnetization phase to its magnetization phase (i.e., the minimum inductor current in a given switching cycle of the power inductor) may be referred to as its valley current. When the valley current is above zero, net energy is pushed to the output of a buck converter. When the valley current is well below zero, energy in the inductor causes a diode of a low-side switching transistor of the buck converter to catch, leading to immediate turn around in inductor current. However, when the valley current is just below zero, the current through the power inductor takes a long time to discharge the switching node of the buck converter, during which time the power inductor continues to decrease, effectively leading to a loss of charge on the output. Such loss of charge and loss of effective duty cycle of the buck converter may lead to an additional unexpected undershoot even for slow load transients. Accordingly, systems and methods for minimizing or eliminating such undershoot may be desired.

### SUMMARY

In accordance with the teachings of the present disclosure, one or more disadvantages and problems associated with operation of power converters at low load conditions may be reduced or eliminated.

In accordance with embodiments of the present disclosure, a system may include a power converter comprising a plurality of switches and a power inductor electrically coupled to the plurality of switches, wherein the plurality of switches are controllable among a plurality of switch configurations in order to generate an output voltage from an input voltage received by the power converter. The system may also include a closed loop controller configured to generate a control signal for controlling the plurality of switches. The system may further include a compensation subsystem configured to measure one or more of a first period of time in which a power inductor current through the power inductor is below zero and a second period of time taken by a voltage of a node of the power converter to drop below a predetermined threshold during a switching dead-time of the power converter. The compensation system may further be configured to based on at least one of the first period of time and the second period of time, modify one or more of a feedforward term to the control signal for controlling the plurality of switches, a loop bandwidth of a control loop comprising the closed loop controller, and a pulse width of the control signal.

In accordance with these and other embodiments of the present disclosure, a method may be provided in a system having a power converter comprising a plurality of switches and a power inductor electrically coupled to the plurality of switches, wherein the plurality of switches are controllable among a plurality of switch configurations in order to generate an output voltage from an input voltage received by the power converter, and the system having a closed loop controller configured to generate a control signal for controlling the plurality of switches. The method may include measuring one or more of a first period of time in which a power inductor current through the power inductor is below zero and a second period of time taken by a voltage of a node of the power converter to drop below a predetermined threshold during a switching dead-time of the power converter. The method may also include based on at least one of the first period of time and the second period of time, modifying one or more of a feedforward term to the control signal for controlling the plurality of switches, a loop bandwidth of a control loop comprising the closed loop controller, and a pulse width of the control signal.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example system for driving a load using a power converter, in accordance with embodiments of the present disclosure; and

FIGS. 2A-2D illustrate waveforms for examples of calculating a period of time in which a power inductor current is below zero, in accordance with embodiments of the present disclosure.

### DETAILED DESCRIPTION

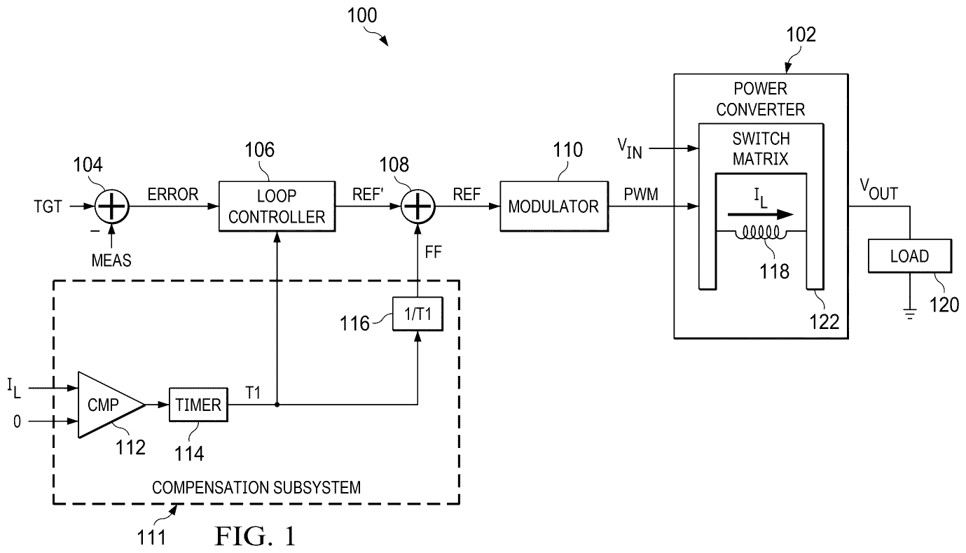

FIG. 1 illustrates a block diagram of selected components of an example system 100 for driving a load 120 using a power converter 102, in accordance with embodiments of the present disclosure. As shown in FIG. 1, system 100 may include power converter 102, signal combiner 104, loop controller 106, signal combiner 108, modulator 110, compensation subsystem 111, and load 120.

Power converter 102 may comprise any suitable system, device, or apparatus configured to drive a power inductor current I_{L} through power inductor 118 and generate a voltage V_{OUT} from a supply voltage V_{IN} based on one or more switch control signals for controlling switches of a switch matrix 122, wherein such switch control signals are provided from modulator 110. Power converter 102 may comprise any suitable power converter, including a buck converter, buck-boost converter, boost converter, two-level power converter, or multi-level power converter (e.g., isolated or non-isolated). In some embodiments, power converter 102 may include a transformer or other magnetic element in lieu of power inductor 118.

Signal combiner 104 may comprise any suitable system, device, or apparatus configured to calculate an error signal ERROR equal to the difference between a target signal TGT and a measured feedback signal MEAS. Target signal TGT may represent a target or desired value for any physical quantity within system 100, including without limitation output voltage V_{OUT}. Likewise, measured feedback signal MEAS may comprise a measured value of such physical quantity (e.g., a measured value for output voltage V_{OUT}). For purposes of clarity and exposition, circuitry for measuring measured feedback signal MEAS is not shown in FIG. 1; however, system 100 may include such circuitry and those of skill in the art would readily have knowledge of how to implement such circuitry to measure measured feedback signal MEAS.

Loop controller 106 may comprise any system, device, or apparatus configured to implement a control loop to regulate measured feedback signal MEAS to track target signal TGT. For example, based on error signal ERROR, loop controller 106 may generate an intermediate reference signal REF′. Such intermediate reference signal REF′ may represent, for example, a commanded duty cycle for power converter 102 to cause regulation of measured feedback signal MEAS to track target signal TGT. Loop controller 106 may be implemented with a proportional (P) controller, proportional-integral (PI) controller, proportional-differential (PD) controller, proportional-integral-differential (PID) controller, or any other suitable controller.

Signal combiner 108 may comprise any suitable system, device, or apparatus configured to calculate a sum of intermediate reference signal REF′ and a feedforward signal FF generated by feedforward generation block 116, in order to generate a reference signal REF to modulator 110. The derivation of feedforward signal FF is described in greater detail below.

Modulator 110 may comprise any suitable system, device, or apparatus configured to receive reference signal REF, and generate one or more switching signals PWM for controlling switching of switches of switch matrix 122 integral to power converter 102. In some embodiments, modulator 110 may comprise a pulse-width modulator.

Load 120 may include any appropriate electrical or electronic load that may be powered from power converter 102, including without limitation a rechargeable battery.

Compensation subsystem 111 may include any suitable system, device, or apparatus configured to provide compensation to minimize or eliminate undershoot on output voltage V_{OUT}, as described in greater detail below. As shown in FIG. 1, compensation subsystem 111 may include a comparator 112, a timer 114, and a feedforward generation block 116.

Comparator 112 may comprise any suitable system, device, or apparatus configured to compare a measured value for power inductor current I_{L} to a programmable threshold (e.g., zero), thus determining when power inductor current I_{L} has crossed below such programmable threshold. For purposes of clarity and exposition, circuitry for measuring power inductor current I_{L} is not shown in FIG. 1, however system 100 may include such circuitry and those of skill in the art would readily have knowledge of how to implement such circuitry to measure power inductor current I_{L}.

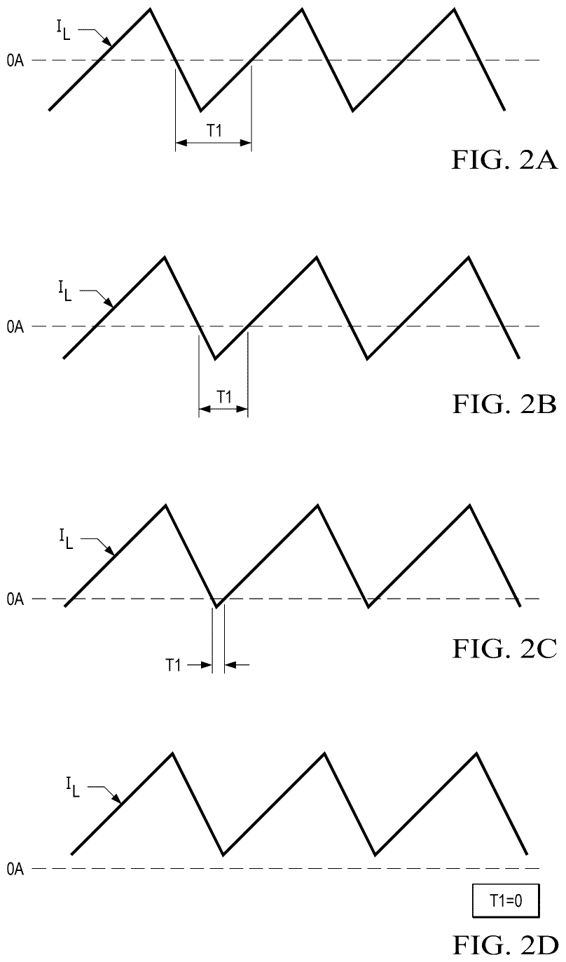

Timer 114 may comprise any suitable system, device, or apparatus configured to, based on a signal output by comparator 112, determine a period of time T1 in which power inductor current I_{L} was below zero in the most-recent switching cycle of power converter 102. For example, reference is made to FIGS. 2A-2D, which show examples of waveforms of power inductor current I_{L} that result in different values of period of time T1, with the value of period of time T1 decreasing from FIG. 2A to FIG. 2B, from FIG. 2B to FIG. 2C, and FIG. 2C to FIG. 2D.

Feedforward generation block 116 may comprise any suitable system, device, or apparatus configured to generate a feedforward signal FF which is a function of the period of time T1.

Feedforward signal FF may be summed with intermediate reference signal REF′ by signal combiner 108 to generate reference signal REF. Thus, in some embodiments, where reference signal REF defines a desired duty cycle for power converter 102, feedforward signal FF may modify the desired duty cycle generated by loop controller 106 to compensate for power inductor current I_{L} falling below zero.

As also shown in FIG. 1, loop controller 106 may also receive period of time T1 and modify coefficients (e.g., proportional coefficient, integral coefficient, and/or differential coefficient) of loop controller 106 based on period of time T1. For example, as period of time T1 approaches zero, the loop coefficients may be adjusted so as to increase the loop bandwidth to be able to maintain tight regulation as the discontinuity is traversed. As a specific example, for a proportional-integral controller, the proportional and integral terms may be increased in value to increase the overall loop bandwidth.

Thus, period of time T1 may be used to optimize the control loop through the presence of feedforward signal FF and/or modifying coefficients of loop controller 106, in order to modify a loop bandwidth of the control loop as a function of period of time T1. Feedforward signal FF may only contribute to control of the feedback loop when power inductor current I_{L} is negative, such that period of time T1 is greater than zero, as shown in FIGS. 2A, 2B, and 2C. Otherwise, if no zero crossing below zero of power inductor current I_{L} occurs as shown in FIG. 2D, both period of time T1 and feedforward signal FF may be zero, and the control loop may operate normally.

The higher the values of period of time T1, the smaller the contribution of the feedforward signal FF may be. As period of time T1 decreases towards zero, feedforward signal FF may increase significantly, assisting the feedback control loop to quickly proceed to a condition in which power inductor current I_{L} is greater than zero. Accordingly, the systems and methods herein may improve system operation by reducing or eliminating unstable conditions, such as those described in the Background section.

In lieu of using period of time T1 to determine a feedforward signal, system 100 may also be adapted to measure an amount of time taken by a switch-node voltage of power converter 102 or another node of power converter 102 to drop below a predetermined threshold voltage during a switching dead time of power converter 102, and then use such period of time as a basis for generating a feedforward signal, modifying coefficients of loop controller 106, and/or modifying a pulse width of the one or more switching signals PWM.

As a result, the systems and methods described above provide for compensation of a loss of pulse width of switching signals PWM resulting from a combination of delays, non-overlap time, and distortion introduced by driver circuitry of power converter 102. Compensation of such lost pulse width (e.g., by adding of feedforward signal FF and/or modification of coefficients of loop controller 106) may modify the duty cycle of power converter 102 (which may modify the pulse width of the one or more switching signals PWM) as a function of the lost pulse width. In some embodiments, the loss in pulse width may be estimated for different voltages and temperatures stored in a look-up table which is used during compensation. In these and other embodiments, the loss in pulse width may be estimated based on an actual measured pulse width of the power converter.

In some embodiments, some or all of system 100 may be embodied in a program of computer-readable instructions and executed by a processing device, including without limitation a processor, application-specific integrated circuit, digital signal processor, or any other suitable processing device.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A system comprising:
a power converter comprising a plurality of switches and a power inductor electrically coupled to the plurality of switches, wherein the plurality of switches are controllable among a plurality of switch configurations in order to generate an output voltage from an input voltage received by the power converter;
a closed loop controller configured to generate a control signal for controlling the plurality of switches; and
a compensation subsystem configured to:
measure one or more of:
a first period of time in which a power inductor current through the power inductor is below zero; and
a second period of time taken by a voltage of a node of the power converter to drop below a predetermined threshold during a switching dead-time of the power converter; and
based on at least one of the first period of time and the second period of time, modify one or more of:
a feedforward term to the control signal for controlling the plurality of switches;
a loop bandwidth of a control loop comprising the closed loop controller; and
a pulse width of the control signal.

2. The system of claim 1, wherein the power converter comprises one of a buck converter, a buck-boost converter, or a boost converter.

3. The system of claim 1, wherein the power converter comprises one of a two-level power converter or a multi-level power converter.

4. The system of claim 1, wherein the closed loop controller is further configured to regulate a physical quantity in accordance with a target signal.

5. The system of claim 4, wherein the physical quantity is the output voltage.

6. The system of claim 1, wherein the closed loop controller is implemented by one of a proportional controller, proportional-integral controller, proportional-differential controller, or proportional-integral-differential controller.

7. The system of claim 1, wherein the control signal defines a duty cycle for the power converter.

8. The system of claim 7, wherein the feedforward term modifies the duty cycle to compensate for the power conductor current being below zero.

9. The system of claim 1, wherein the compensation system modifies the loop bandwidth by modifying one or more coefficients of the closed loop controller.

10. The system of claim 1, wherein the feedforward term is a function of one of the first period of time and the second period of time.

11. A method comprising, in a system having a power converter comprising a plurality of switches and a power inductor electrically coupled to the plurality of switches, wherein the plurality of switches are controllable among a plurality of switch configurations in order to generate an output voltage from an input voltage received by the power converter, and the system having a closed loop controller configured to generate a control signal for controlling the plurality of switches:
measuring one or more of:
a first period of time in which a power inductor current through the power inductor is below zero; and
a second period of time taken by a voltage of a node of the power converter to drop below a predetermined threshold during a switching dead-time of the power converter; and
based on at least one of the first period of time and the second period of time, modifying one or more of:
a feedforward term to the control signal for controlling the plurality of switches;
a loop bandwidth of a control loop comprising the closed loop controller; and
a pulse width of the control signal.

12. The method of claim 11, wherein the power converter comprises one of a buck converter, a buck-boost converter, or a boost converter.

13. The method of claim 11, wherein the power converter comprises one of a two-level power converter or a multi-level power converter.

14. The method of claim 11, wherein the closed loop controller is further configured to regulate a physical quantity in accordance with a target signal.

15. The method of claim 14, wherein the physical quantity is the output voltage.

16. The method of claim 11, wherein the closed loop controller is implemented by one of a proportional controller, proportional-integral controller, proportional-differential controller, or proportional-integral-differential controller.

17. The method of claim 11, wherein the control signal defines a duty cycle for the power converter.

18. The method of claim 17, wherein the feedforward term modifies the duty cycle to compensate for the power conductor current being below zero.

19. The method of claim 11, wherein modifying the loop bandwidth comprises modifying one or more coefficients of the closed loop controller.

20. The method of claim 11, wherein the feedforward term is a function of one of the first period of time and the second period of time.
